(19) United States
(12) Patent Application Publication
(10) Pub. No.: US 2012/0164561 A1
(43) Pub. Date: Jun. 28, 2012

(54) Zinc Comprising Nanoparticles And Related Nanotechnology

(76) Inventor: Tapesh Yadav, Longmont, CO (US)

(21) Appl. No.: 12/121,099

(22) Filed: May 15, 2008

Related U.S. Application Data
(62) Division of application No. 10/780,671, filed on Feb. 19, 2004, now abandoned.

(51) Int. Cl. H01M 4/86; H01M 4/60; H01M 4/04; H01M 4/48; H01M 4/42; B05D 5/12; B82Y 30/00

(52) U.S. Cl. 429/530; 429/229; 429/224; 429/213; 429/532; 427/126.3; 427/126.2; 252/519.51; 252/519.33; 977/811; 977/832; 977/948

(57) ABSTRACT

Nanoparticles comprising zinc, methods of manufacturing nanoparticles comprising zinc, and applications of nanoparticles comprising zinc, such as electrically conducting formulations, reagents for fine chemical synthesis, pigments and catalysts are provided, and more particularly, a coating, comprising a nanomaterial composition comprising zinc and at least one metal other than zinc, wherein the at least one metal comprises an element that (a) has an oxidation state higher than an oxidation state of zinc and that (b) dopes zinc in the nanomaterial composition, and wherein the coating has an electrical conductivity greater than 0.0001 mhos·cm.

### CROSS-REFERENCE TO RELATED PATENT APPLICATIONS

This application is a divisional of application Ser. No. 10/780,671, filed Feb. 19, 2004, and claims the benefit under 35 USC §119(e) of U.S. Application No. 60/449,626, filed Feb. 24, 2003, each application is explicitly incorporated herein by reference in its entirety.

### FIELD OF THE INVENTION

The present invention relates to methods of manufacturing submicron and nanoscale powders comprising zinc and applications of such powders.

### RELEVANT BACKGROUND

Nanopowders in particular and sub-micron powders in general are a novel family of materials whose distinguishing feature is that their domain size is so small that size confinement effects become a significant determinant of the materials' performance. Such confinement effects can, therefore, lead to a wide range of commercially important properties. Nanopowders, therefore, are an extraordinary opportunity for design, development and commercialization of a wide range of devices and products for various applications. Furthermore, since they represent a whole new family of material precursors where conventional coarse-grain physiochemical mechanisms are not applicable, these materials offer unique combinations of properties that can enable novel and multifunctional components of unmatched performance. Yadav et al. in U.S. Pat. No. 6,344,271 and in co-pending and commonly assigned U.S. patent application Ser. Nos. 09/638,977 (U.S. Pat. No. 6,569,397), 10/004,387 (US 2003-0102099 A1 & U.S. Pat. No. 6,652,967), 10/071,027 (US 2002-0178865 A1 & U.S. Pat. No. 6,719,821), 10/113,315 (US 2003-0124050 A1 & U.S. Pat. No. 6,832,735), and 10/292,263 (US 2003-0132420 A1 & U.S. Pat. No. 7,029,507) all of which along with the references contained therein are hereby incorporated by reference in their entirety, teach some applications of sub-micron and nanoscale powders.

### SUMMARY OF THE INVENTION

Briefly stated, the present invention involves methods for manufacturing nanoscale powders comprising zinc and applications thereof.

In some embodiments, the present invention is nanoparticles of doped or undoped zinc oxides

In some embodiments, the present invention is methods for manufacturing doped or undoped metal oxides comprising zinc.

In some embodiments, the present invention is oxide composites and coatings that comprise doped or undoped zinc.

In some embodiments, the present invention is applications of powders comprising doped or undoped zinc oxides.

In some embodiments, the present invention is superior ultraviolet absorbing pigment for a variety of applications.

In some embodiments, the present invention is superior catalysts for a variety of applications.

In some embodiments, the present invention is superior additives for a variety of applications.

In some embodiments, the present invention is materials and devices for optical, sensing, thermal, biomedical, structural, superconductive, energy, security and other uses.

In some embodiments, the present invention is methods for producing novel nanoscale powders comprising zinc in high volume, low-cost, and reproducible quality.

### BRIEF DESCRIPTION OF THE DRAWINGS

FIG. 1 shows an exemplary overall approach for producing submicron and nanoscale powders in accordance with the present invention.

### DETAILED DESCRIPTION OF THE PREFERRED EMBODIMENTS

This invention is generally directed to very fine powders comprising zinc (Zn). The scope of the teachings includes high purity powders. Powders discussed herein are of mean crystallite size less than 1 micron, and in certain embodiments less than 100 nanometers. Methods for producing and utilizing such powders in high volume, low-cost, and reproducible quality are also outlined.

### DEFINITIONS

For purposes of clarity the following definitions are provided to aid the understanding of the description and specific examples provided herein:

“Fine powders” as used herein, refers to powders that simultaneously satisfy the following criteria:

(1) particles with mean size less than 10 microns; and
(2) particles with aspect ratio between 1 and 1,000,000.

For example, in some embodiments, the fine powders are powders that have particles with a mean domain size less than 5 microns and with an aspect ratio ranging from 1 to 1,000,000.

“Submicron powders” as used herein, refers to fine powders with a mean size less than 1 micron. For example, in some embodiments, the submicron powders are powders that have particles with a mean domain size less than 500 nanometers and with an aspect ratio ranging from 1 to 1,000,000.

The terms “nanopowders,” “nanosize powders,” “nanoparticles,” and “nanoscale powders” are used interchangeably and refer to fine powders that have a mean size less than 250 nanometers. For example, in some embodiments, the nanopowders are powders that have particles with a mean domain size less than 100 nanometers and with an aspect ratio ranging from 1 to 1,000,000.

Pure powders, as the term used herein, are powders that have composition purity of at least 99.9% by metal basis. For example, in some embodiments the purity is 99.99%.

Nanomaterials, as the term used herein, are materials in any dimensional form and domain size less than 100 nanometers.

“Domain size,” as that term is used herein, refers to the minimum dimension of a particular material morphology. In the case of powders, the domain size is the grain size. In the case of whiskers and fibers, the domain size is the diameter. In the case of plates and films, the domain size is the thickness.

The terms “powder,” “particle,” and “grain” are used interchangeably and encompass oxides, carbides, nitrides, borides, chalcogenides, halides, metals, intermetallics, ceramics, polymers, alloys, and combinations thereof. These terms include single metal, multi-metal, and complex compositions. These terms further include hollow, dense, porous, semi-porous, coated, uncoated, layered, laminated, simple, complex, dendritic, inorganic, organic, elemental, non-elemental, composite, doped, undoped, spherical, non-spherical, surface functionalized, surface non-functionalized, stoichiometric, and non-stoichiometric forms or substances. Further, the term powder in its generic sense includes one-dimensional materials (fibers, tubes, etc.), two-dimensional materials (platelets, films, laminates, planar, etc.), and three-dimensional materials (spheres, cones, ovals, cylindrical, cubes, monoclinic, parallelolipids, dumbbells, hexagonal, truncated dodecahedron, irregular shaped structures, etc.).

“Aspect ratio,” as the term is used herein, refers to the ratio of the maximum to the minimum dimension of a particle.

“Precursor,” as the term is used herein, encompasses any raw substance that can be transformed into a powder of same or different composition. In certain embodiments, the precursor is a liquid. The term precursor includes, but is not limited to, organometallics, organics, inorganics, solutions, dispersions, melts, sols, gels, emulsions, or mixtures.

“Powder,” as the term is used herein, encompasses oxides, carbides, nitrides, chalcogenides, metals, alloys, and combinations thereof. The term includes hollow, dense, porous, semi-porous, coated, uncoated, layered, laminated, simple, complex, dendritic, inorganic, organic, elemental, non-elemental, dispersed, composite, doped, undoped, spherical, non-spherical, surface functionalized, surface non-functionalized, stoichiometric, and non-stoichiometric forms or substances.

“Coating” (or “film” or “laminate” or “layer”), as the term is used herein, encompasses any deposition comprising submicron and nanoscale powders. The term includes in its scope a substrate or surface or deposition or a combination that is hollow, dense, porous, semi-porous, coated, uncoated, simple, complex, dendritic, inorganic, organic, composite, doped, undoped, uniform, non-uniform, surface functionalized, surface non-functionalized, thin, thick, pretreated, post-treated, stoichiometric, or non-stoichiometric form or morphology.

“Dispersion,” as the term is used herein, encompasses inks, pastes, creams, lotions, Newtonian, non-Newtonian, uniform, non-uniform, transparent, translucent, opaque, white, black, colored, emulsified, with additives, without additives, water-based, polar solvent-based, or non-polar solvent-based mixture of powder in any fluid or fluid-like state of substance.

This invention is directed to submicron and nanoscale powders comprising doped or undoped zinc oxides in certain embodiments. Given the relative abundance of zinc in the earth's crust and current limitations on purification technologies, it is expected that many commercially produced materials would have naturally occurring zinc impurities. These impurities are expected to be below 100 parts per million and in most cases in concentration similar to other elemental impurities. Removal of such impurities does not materially affect the properties of interest to an application. For the purposes herein, powders comprising zinc impurities wherein zinc is present in a concentration similar to other elemental impurities are excluded from the scope of this invention. However, it is emphasized that in one or more doped or undoped compositions of matter, zinc may be intentionally engineered as a dopant into a powder at concentrations of 100 ppm or less, and these are included in the scope of this patent.

In generic sense, the invention teaches nanoscale powders, and in more generic sense, submicron powders comprising at least 100 ppm by weight, in some embodiments greater than 1 weight % by metal basis, and in other embodiments greater than 10 weight % by metal basis of zinc (Zn).

While several embodiments for manufacturing nanoscale and submicron powders comprising zinc are disclosed, for the purposes herein, the nanoscale or submicron powders may be produced by any method or may result as a byproduct from any process.

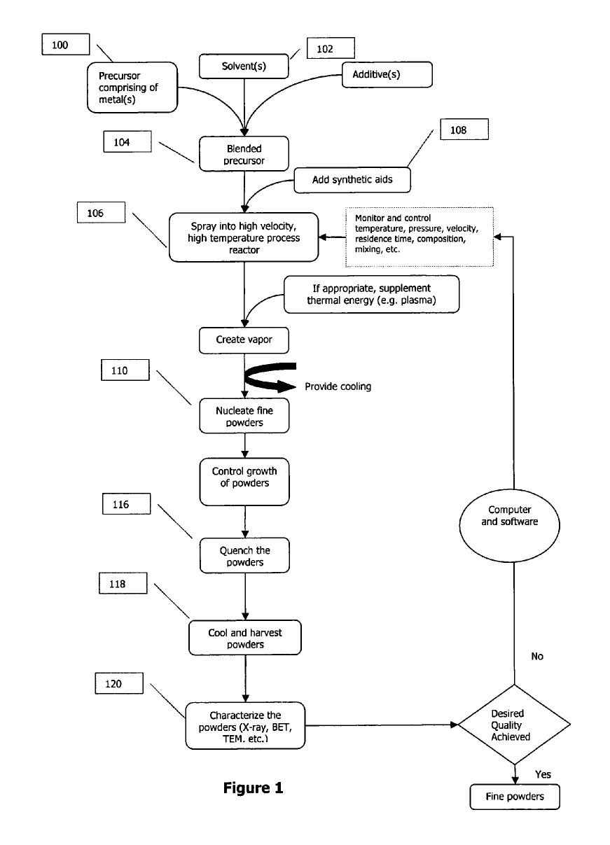

FIG. 1 shows an exemplary overall approach for the production of submicron powders in general and nanopowders in particular. The process shown in FIG. 1 begins with a zinc containing raw material (for example, but not limited to, coarse oxide powders, metal powders, salts, slurries, waste products, organic compounds, or inorganic compounds). FIG. 1 shows one embodiment of a system for producing nanoscale and submicron powders in accordance with the present invention.

The process shown in FIG. 1 begins at 100 with a zinc metal-containing precursor such as an emulsion, fluid, particle-containing fluid suspension, or water-soluble salt. The precursor may be evaporated zinc metal vapor, evaporated alloy vapor, a gas, a single-phase liquid, a multi-phase liquid, a melt, a sol, a solution, fluid mixtures, solid suspension, or combinations thereof. The metal-containing precursor comprises a stoichiometric or a non-stoichiometric metal composition with at least some part in a fluid phase. Fluid precursors are utilized in certain embodiments of this invention. Typically, fluids are easier to convey, evaporate, and thermally process, and the resulting product is more uniform.

In one embodiment of this invention, the precursors are environmentally benign, safe, readily available, high-metal loading, lower-cost fluid materials. Examples of zinc metal-containing precursors suitable for purposes of this invention include, but are not limited to, metal acetates, metal carboxylates, metal ethanoates, metal alkoxides, metal octoates, metal chelates, metallo-organic compounds, metal halides, metal azides, metal nitrates, metal sulfates, metal hydroxides, metal salts soluble in organics or water, and metal-containing emulsions.

In another embodiment, multiple metal precursors may be mixed if complex nano-nanoscale and submicron powders are desired. For example, a zinc precursor and praseodymium precursor may be mixed to prepare praseodymium doped zinc oxide powders for pigment applications. As another example, a zinc precursor and copper precursor may be mixed in correct proportions to yield a high purity, high surface area, mixed oxide powder for catalyst applications. In yet another example, a cobalt precursor and a zinc precursor may be mixed to yield powders for electroceramic varistor device applications. Such complex nanoscale and submicron powders can help create materials with surprising and unusual properties not available through the respective single metal oxides or a simple nanocomposite formed by physically blending powders of different compositions.

It is desirable to use precursors of a higher purity to produce a nanoscale or submicron powder of a desired purity. For example, if a purity greater than x % (by metal weight basis) is desired, one or more precursors that are mixed and used may have purities greater than or equal to x % (by metal weight basis) to practice the teachings herein.

With continued reference to FIG. 1, the metal-containing precursor 100 (containing one or a mixture of metal-containing precursors) is fed into a high temperature process 106, which may be implemented using a high temperature reactor, for example. In some embodiments, a synthetic aid such as a reactive fluid 108 may be added along with the precursor 100 as it is being fed into the reactor 106. Examples of such reactive fluids include, but are not limited to, hydrogen, ammonia, halides, carbon oxides, methane, oxygen gas, and air.

While the above examples specifically teach methods of preparing nanoscale and submicron powders of oxides, the teachings may be readily extended in an analogous manner to other compositions such as carbides, nitrides, borides, carbonitrides, and chalcogenides. In some embodiments, high temperature processing may be used. However, a moderate temperature processing or a low/cryogenic temperature processing may also be employed to produce nanoscale and submicron powders using the methods of the present invention.

The precursor 100 may be pre-processed in a number of other ways before any thermal treatment. For example, the pH may be adjusted to ensure precursor stability. Alternatively, selective solution chemistry, such as precipitation with or without the presence of surfactants or other synthesis aids, may be employed to form a sol or other state of matter. The precursor 100 may be pre-heated or partially combusted before the thermal treatment.

The precursor 100 may be injected axially, radially, tangentially, or at any other angle into the high temperature region 106. As stated above, the precursor 100 may be pre-mixed or diffusionally mixed with other reactants. The precursor 100 may be fed into the thermal processing reactor by a laminar, parabolic, turbulent, pulsating, sheared, or cyclonic flow pattern, or by any other flow pattern. In addition, one or more metal-containing precursors 100 can be injected from one or more ports in the reactor 106. The feed spray system may yield a feed pattern that envelops the heat source or, alternatively, the heat sources may envelop the feed, or alternatively, various combinations of this may be employed. In some embodiments, the spray is atomized and sprayed in a manner that enhances heat transfer efficiency, mass transfer efficiency, momentum transfer efficiency, and reaction efficiency. The reactor shape may be cylindrical, spherical, conical, or any other shape. Methods and equipment such as those taught in U.S. Pat. Nos. 5,788,738, 5,851,507, and 5,984,997 (each of which is specifically incorporated herein by reference) can be employed in practicing the methods of this invention.

With continued reference to FIG. 1, after the precursor 100 has been fed into reactor 106, it may be processed at high temperatures to form the product powder. In other embodiments, the thermal processing may be performed at lower temperatures to form the powder product. The thermal treatment may be done in a gas environment with the aim to produce products, such as powders, that have the desired porosity, density, morphology, dispersion, surface area, and composition. This step produces by-products such as gases. To reduce costs, these gases may be recycled, mass/heat integrated, or used to prepare the pure gas stream desired by the process.

In embodiments using high temperature thermal processing, the high temperature processing may be conducted at step 106 (FIG. 1) at temperatures greater than 1500 K, in some embodiments greater than 2500 K, in some embodiments greater than 3000 K, and in some embodiments greater than 4000 K. Such temperatures may be achieved by various methods including, but not limited to, plasma processes, combustion, pyrolysis, electrical arcing in an appropriate reactor, and combinations thereof. The plasma may provide reaction gases or may provide a clean source of heat.

A high temperature thermal process at 106 results in a vapor comprising fine powders. After the thermal processing, this vapor is cooled at step 110 to nucleate submicron powders, in certain embodiments nanopowders. In certain embodiments, the cooling temperature at step 110 is maintained high enough to prevent moisture condensation. The dispersed particles form because of the thermokinetic conditions in the process. By engineering the process conditions, such as pressure, residence time, supersaturation and nucleation rates, gas velocity, flow rates, species concentrations, diluent addition, degree of mixing, momentum transfer, mass transfer, and heat transfer, the morphology of the nanoscale and submicron powders can be tailored. It is important to note that the focus of the process should be on producing a powder product that excels in satisfying the end application requirements and customer needs.

In certain embodiments, the nanopowder is quenched after cooling to lower temperatures at step 116 to minimize and prevent agglomeration or grain growth. Suitable quenching methods include, but are not limited to, methods taught in U.S. Pat. No. 5,788,738. In certain embodiments, sonic to supersonic quenching may be used. In other embodiments, coolant gases, water, solvents, cold surfaces, or cryogenic fluids might be employed. In certain embodiments, quenching methods are employed which can prevent deposition of the powders on the conveying walls. These methods may include, but are not limited to, electrostatic means, blanketing with gases, the use of higher flow rates, mechanical means, chemical means, electrochemical means, or sonication/vibration of the walls.

In some embodiments, the high temperature processing system includes instrumentation and software that can assist in the quality control of the process. Furthermore, in certain embodiments, the high temperature processing zone 106 is operated to produce fine powders 120, in certain embodiments submicron powders, and in certain embodiments nanopowders. The gaseous products from the process may be monitored for composition, temperature, and other variables to ensure quality at step 112 (FIG. 1). The gaseous products may be recycled to be used in process 108 or used as a valuable raw material when nanoscale and submicron powders 120 have been formed, or they may be treated to remove environmental pollutants if any. Following quenching step 116, the nanoscale and submicron powders may be cooled further at step 118 and then harvested at step 120.

The product nanoscale and submicron powders 120 may be collected by any method. Suitable collection means include, but are not limited to, bag filtration, electrostatic separation, membrane filtration, cyclones, impact filtration, centrifugation, hydrocyclones, thermophoresis, magnetic separation, and combinations thereof.

The quenching at step 116 may be modified to enable preparation of coatings. In such embodiments, a substrate may be provided (in batch or continuous mode) in the path of the quenching powder containing gas flow. By engineering the substrate temperature and the powder temperature, a coating comprising the submicron powders and nanoscale powders can be formed.

In some embodiments, a coating, film, or component may also be prepared by dispersing the fine nanopowder and then applying various known methods, such as, but not limited to, electrophoretic deposition, magnetophorectic deposition, spin coating, dip coating, spraying, brushing, screen printing, ink-jet printing, toner printing, and sintering. The nanopowders may be thermally treated or reacted to enhance their electrical, optical, photonic, catalytic, thermal, magnetic, structural, electronic, emission, processing, or forming properties before such a step.

It should be noted that the intermediate or product at any stage of the process described herein, or similar process based on modifications by those skilled in the art, may be used directly as a feed precursor to produce nanoscale or fine powders by methods taught herein and other methods. Other suitable methods include, but not limited to, those taught in commonly owned U.S. Pat. Nos. 5,788,738, 5,851,507, and 5,984,997, and co-pending U.S. patent application Ser. Nos. 09/638,977 (U.S. Pat. No. 6,569,397) and 60/310,967 which are all incorporated herein by reference in their entirety. For example, a sol may be blended with a fuel and then utilized as the feed precursor mixture for thermal processing above 2500 K to produce nanoscale simple or complex powders.

In summary, one embodiment for manufacturing powders consistent with teachings herein, comprises (a) preparing a precursor comprising at least 100 ppm by weight of zinc element; (b) feeding the precursor into a high temperature reactor operating at temperatures greater than 1500 K, in certain embodiments greater than 2500 K, in certain embodiments greater than 3000 K, and in certain embodiments greater than 4000 K; (c) wherein, in the high temperature reactor, the precursor converts into vapor comprising the rare earth metal in a process stream with a velocity above 0.25 mach in an inert or reactive atmosphere; (d) the vapor is cooled to nucleate submicron or nanoscale powders; (e) the powders are then quenched at high gas velocities to prevent agglomeration and growth; and (f) the quenched powders are filtered from the gases.

Another embodiment for manufacturing nanoscale powders comprising zinc consistent with teachings herein, comprises (a) preparing a fluid precursor comprising two or more metals, at least one of which is zinc in a concentration greater than 100 ppm by weight; (b) feeding the said precursor into a high temperature reactor operating at temperatures greater than 1500 K, in some embodiments greater than 2500 K, in some embodiments greater than 3000 K, and in some embodiments greater than 4000 K in an inert or reactive atmosphere; (c) wherein, in the said high temperature reactor, the said precursor converts into vapor comprising zinc; (d) the vapor is cooled to nucleate submicron or nanoscale powders; (e) the powders are then quenched at gas velocities exceeding 0.1 Mach to prevent agglomeration and growth; and (f) the quenched powders are separated from the gases. In certain embodiments, the fluid precursor may include synthesis aids such as surfactants (also known as dispersants, capping agents, emulsifying agents, etc.) to control the morphology or to optimize the process economics and/or product performance.

One embodiment for manufacturing coatings comprises (a) preparing a fluid precursor comprising one or more metals, one of which is zinc; (b) feeding the said precursor into a high temperature reactor operating at temperatures greater than 1500 K, in some embodiments greater than 2500 K, in some embodiments greater than 3000 K, and in some embodiments greater than 4000 K in an inert or reactive atmosphere; (c) wherein, in the high temperature reactor, the precursor converts into vapor comprising the zinc; (d) the vapor is cooled to nucleate submicron or nanoscale powders; (e) the powders are then quenched onto a substrate to form a coating on the substrate comprising zinc.

The powders produced by teachings herein may be modified by post-processing as taught by commonly owned U.S. patent application Ser. No. 10/113,315 (US 2003-0124050 A1 & U.S. Pat. No. 6,832,735), which is hereby incorporated by reference in its entirety.

Methods for Incorporating Nanoparticles into Products

The submicron and nanoscale powders taught herein may be incorporated into a composite structure by any method. Some non-limiting exemplary methods are taught in commonly owned U.S. Pat. No. 6,228,904 which is hereby incorporated by reference in its entirety.

The submicron and nanoscale powders taught herein may be incorporated into plastics by any method. In one embodiment, the method comprises (a) preparing nanoscale or submicron powders comprising zinc by any method, such as a method that employs fluid precursors and a peak processing temperature exceeding 1500 K; (b) providing powders of one or more plastics; (c) mixing the nanoscale or submicron powders with the powders of plastics; and (d) co-extruding the mixed powders into a desired shape at temperatures greater than the softening temperature of the powders of plastics but less than the degradation temperature of the powders of plastics. In another embodiment, a masterbatch of the plastic powder comprising nanoscale or submicron powders comprising zinc is prepared. These masterbatches can later be processed into useful products by techniques well known to those skilled in the art. In yet another embodiment, the zinc metal containing nanoscale or submicron powders are pretreated to coat the powder surface for ease in dispersability and to ensure homogeneity. In a further embodiment, injection molding of the mixed powders comprising nanoscale powders and plastic powders is employed to prepare useful products.

One embodiment for incorporating nanoscale or submicron powders into plastics comprises (a) preparing nanoscale or submicron powders comprising zinc by any method, such as a method that employs fluid precursors and peak processing temperature exceeding 1500 K; (b) providing a film of one or more plastics, wherein

the film may be laminated, extruded, blown, cast, or molded; and (c) coating the nanoscale or submicron powders on the film of plastic by techniques such as spin coating, dip coating, spray coating, ion beam coating, sputtering. In another embodiment, a nanostructured coating is formed directly on the film by techniques such as those taught in herein. In some embodiments, the grain size of the coating is less than 200 nm, in some embodiments less than 75 nm, and in some embodiments less than 25 nm.

The submicron and nanoscale powders taught herein may be incorporated into glass by any method. In one embodiment, nanoparticles of zinc are incorporated into glass by (a) preparing nanoscale or submicron powders comprising zinc by any method, such as a method that employs fluid precursors and temperature exceeding 1500 K in an inert or reactive atmosphere; (b) providing glass powder or melt; (c) mixing the nanoscale or submicron powders with the glass powder or melt; and (d) processing the glass comprising nanoparticles into articles of desired shape and size.

The submicron and nanoscale powders taught herein may be incorporated into paper by any method. In one embodiment, the method comprises (a) preparing nanoscale or submicron powders comprising zinc; (b) providing paper pulp; (c) mixing the nanoscale or submicron powders with the paper pulp; and (d) processing the mixed powders into paper by steps such as molding, couching and calendering. In another embodiment, the zinc metal containing nanoscale or submicron powders are pretreated to coat the powder surface for ease in dispersability and to ensure homogeneity. In a further embodiment, nanoparticles are applied directly on the manufactured paper or paper-based product; the small size of nanoparticles enables them to permeate through the paper fabric or reside on the surface of the paper and thereby functionalize the paper.

The submicron and nanoscale powders taught herein may be incorporated into leather, fibers, or fabric by any method. In one embodiment, the method comprises (a) preparing nanoscale or submicron powders comprising zinc by any method, such as a process that includes a step that operates above 1000 K; (b) providing leather, fibers, or fabric; (c) bonding the nanoscale or submicron powders with the leather, fibers, or fabric; and (d) processing the bonded leather, fibers, or fabric into a product. In yet another embodiment, the zinc metal containing nanoscale or submicron powders are pretreated to coat or functionalize the powder surface for ease in bonding or dispersability or to ensure homogeneity. In a further embodiment, nanoparticles are applied directly on a manufactured product based on leather, fibers, or fabric; the small size of nanoparticles enables them to adhere to or permeate through the leather, fibers (polymer, wool, cotton, flax, animal-derived, agri-derived), or fabric and thereby functionalize the leather, fibers, or fabric.

The submicron and nanoscale powders taught herein may be incorporated into creams or inks by any method. In one embodiment, the method comprises (a) preparing nanoscale or submicron powders comprising zinc by any method, such as a method that employs fluid precursors and peak processing temperature exceeding 1500 K; (b) providing a formulation of cream or ink; and (c) mixing the nanoscale or submicron powders with the cream or ink. In yet another embodiment, the zinc comprising nanoscale or submicron powders are pretreated to coat or functionalize the powder surface for ease in dispersability and to ensure homogeneity. In a further embodiment, pre-existing formulation of a cream or ink is mixed with nanoscale or submicron powders to functionalize the cream or ink.

Nanoparticles comprising zinc can be difficult to disperse in water, solvents, plastics, rubber, glass, paper, etc. The dispersability of the nanoparticles can be enhanced by treating the surface of the zinc oxide powders or other zinc comprising nanoparticles. For example, fatty acids (e.g. propionic acid, stearic acid and oils) can be applied to or with the nanoparticles to enhance the surface compatibility. If the powder has an acidic surface, ammonia, quaternary salts, or ammonium salts can be applied to the surface to achieve desired surface pH. In other cases, acetic acid wash can be used to achieve the desired surface state. Trialkyl phosphates and phosphoric acid can be applied to reduce dusting and chemical activity. In yet other cases, the powder may be thermally treated to improve the dispersability of the powder.

### Applications of Nanoparticles and Submicron Powders Comprising Zinc

### Pigments

Nanoparticles of zinc containing multi-metal oxides offer some surprising and unusual benefits as pigments. Nanoparticles are smaller than the visible wavelengths of light which leads to visible wavelengths interacting in unusual ways with nanoparticles compared to particles with grain sizes much bigger than the visible wavelengths (400-700 nm). The small size of nanoparticles can also lead to more uniform dispersion. In certain embodiments, it is important that the nanoparticles be non-agglomerated (i.e. do not have sintered neck formation or hard agglomeration). In some embodiments, the nanoparticles have non-functionalized, i.e. clean surface; in other embodiments, the surface is modified or functionalized to enable bonding with the matrix in which they need to be dispersed.

One of the outstanding process challenges for manufacturing inorganic pigments is the ability to ensure homogeneous lattice level mixing of elements in a complex multi-metal formulation. One of the features of the process described herein is its ability to prepare complex compositions with the necessary homogeneity. Therefore, the teachings herein are ideally suited for creating color and making superior performing pigments with nanoparticles comprising zinc.

Some non-limiting illustrations of pigments containing zinc are cobalt zinc-silicate, ceria nanolayer coated cobalt zinc-silicate, zinc chromate, zinc ferrite, zinc dust, and non-stoichiometric substances comprising zinc.

In one embodiment, a method for manufacturing a pigmented product comprises (a) preparing nanoscale or submicron powders comprising zinc; (b) providing powders of one or more plastics; (c) mixing the nanoscale or submicron powders with the powders of plastics; and (d) processing the mixed powders into the product. In yet another embodiment, the zinc containing nanoscale or submicron powders are pretreated to coat the powder surface for ease in dispersability and to ensure homogeneity. In a further embodiment, extrusion or injection molding of the mixed powders comprising nanoscale powders and plastic powders can be employed to prepare useful products.

### Additives

Ultraviolet radiation in the 280-400 nm range causes most damage to consumer products exposed to sun light. Furthermore, ultraviolet radiation is also known to be harmful to human skin. Methods for protecting consumer products and ultraviolet filters are commercially needed. Organic pigments and additives are currently utilized to provide such protection. However, such organic pigments have a limited life as they provide the protection by sacrificially absorbing ultraviolet radiation while undergoing degradation. More permanent, long lasting protection is desired.

Nanoparticles of metal oxides comprising zinc elements, particularly those that contain two or more metals at least one of which is zinc, offer a unique and surprising way to provide such long lasting superior protection. It is important to tailor the particle size distribution such that it is less than the wavelength of visible light (that is, the d₉₉ of particle size distribution should be less than 200 nm, in certain embodiments less than 100 nm). Once such oxide nanoscale powder comprising Zn is available, it can be utilized to shield ultraviolet radiation and consequent damage. The presence of one or more additional metals in the zinc oxide lattice reduces the photocatalytic behavior of zinc oxide such as is known to those in the art (e.g. see Eggins et al., Journal of Photochemistry and Photobiology A: Chemistry 118 (1998) pages 31-40). It is desirable to reduce this inherent photoactivity of zinc oxide which can cause secondary and undesired photocatalytic damage. Oxides comprising two or more metals one of which being zinc, in certain embodiments with zinc greater than 75% by metal weight, can reduce or eliminate this photocatalytic effect. The metals combined with zinc at lattice level to form a multi-metal oxide can be any metal. Suitable metals include, but are not limited to, aluminum, copper, titanium, silicon, magnesium, calcium, barium, iron, nickel, cobalt, chromium, tantalum, niobium, silver, gold, tin, antimony, indium, zirconium, tungsten, molybdenum, vanadium, sodium, potassium, lithium, bismuth, hafnium, and rare earth metals.

Ultraviolet blocking submicron and nanoscale powders taught herein may be incorporated into plastics, wood, fabric, paints, furniture, glass, paper, food packaging materials, housing products, flooring products, car interiors, cosmetics, and other consumer products by techniques discussed herein or any other suitable method.

In one embodiment, a method for protecting products from the damaging effects of ultraviolet radiation comprises (a) preparing nanoscale or submicron powders comprising zinc by any process, in certain embodiments wherein one or more additional metals are present in combination with zinc at the lattice level; (b) providing powders of one or more constituents of the product (e.g. plastics); (c) mixing the nanoscale or submicron powders with the one or more constituents of the product; and (d) processing the mixed powders into a desired shape. In another embodiment, the zinc metal containing nanoscale or submicron powders are pretreated to coat the powder surface for ease in dispersability and to ensure homogeneity. In a further embodiment, extrusion or injection molding of the mixed powders comprising nanoscale powders and plastic powders can be employed to prepare useful products.

In another embodiment, a method for protecting ultraviolet radiation comprises (a) preparing nanoscale or submicron powders comprising zinc; (b) providing a film of one or more plastics, wherein the film may be laminated, extruded, blown, cast, or molded; (c) coating the nanoscale or submicron powders on the film of plastic by techniques such as, but not limited to, spin coating, dip coating, spray coating, ion beam coating, vapor deposition, and sputtering.

In other embodiments of a method for protecting goods from ultraviolet radiation, glass may be used instead of plastics. In a similar way, ultraviolet protective capability can be added to composites, wood, adhesives, fabric, paints, inks, furniture, leather, paper, food packaging materials, housing products, flooring products, car interiors, biomedical storage products, blood storage containers, bio-fluid containers, road signs, and indicators.

In yet other embodiments, human and pet skin may be protected from ultraviolet radiation using the following method: (a) prepare nanoscale or submicron powders comprising zinc in a process such as those described herein; (b) provide a medium, such as cream, base, wax, spray, or solution; (c) disperse the nanoscale or submicron powders into the medium; and (d) apply the medium over the surface that needs protection. An embodiment is to use this method with existing cosmetics or personal care product.

The teachings above are also useful in protecting vegetables, fruits, meats and packaged food. It is well known that foods that contain fats or oils (potato chips, snacks, meat, soups, etc.) degrade when exposed to light, in particular when exposed to ultraviolet radiation. In one embodiment, a method for enhancing the storage life of food and of protecting food comprises (a) preparing nanoscale or submicron powders comprising zinc and/or additional metals by any method, such as the method taught herein; (b) providing powders or films of one or more plastics; (c) mixing or coating the nanoscale or submicron powders onto the plastic film (laminates) or with the powders of plastics; (d) processing the film or mixed powders into a desired package or shape. Current techniques for protecting fat containing food is to package them in metal or paper cans or in laminated plastic bags that include a metal layer such as aluminum. These traditional techniques prevent the consumer from viewing the quality of the product and thereby limit the ability for marketing premium products. A surprising advantage of the approach taught herein for protecting food is the ability to maintain visual transparency of the packaging material while eliminating over 95%, and in other embodiments 99% or more, of the ultraviolet radiation reaching the product. In another embodiment, this technique is used to protect biomedical products, device components, and pharma products sensitive to ultraviolet radiation. For example, this technique can be utilized to protect medicines, bioactive liquid droplets, tracers, markers, biomedical reagents, blood, biological samples, device tubing, catheters, angioplasty kits, components, etc. In a further embodiment, instead of plastics, glass is used as the packaging materials in combination with nanoscale and submicron powders to provide protection from UV radiation. One advantage of zinc-based UV absorbing powder is that they are environmentally benign when the product is disposed or destroyed by techniques such as incineration. While the teachings herein specifically discuss the use of zinc metal comprising nanoscale and submicron powders, other compositions of powders that absorb UV radiation can also be employed in the same way to deliver similar benefits to consumers.

The teachings herein are also useful in protecting wood, construction products, and adhesives. Wood, construction products, and numerous commercial adhesives degrade when exposed to light, in particular when exposed to ultraviolet radiation. In one embodiment, a method for enhancing the useful life of wood products comprises (a) preparing nanoscale or submicron powders comprising zinc and/or other metals by any method, such as the method taught herein; (b) providing a wood product; (c) permeating or coating the nanoscale or submicron powders on the wood product; and (d) thereby reducing the UV exposure to the wood and reducing the degradation of the wood product by UV light. A surprising advantage of the approach taught herein for protecting wood is (a) the ability of nanoparticles to infiltrate the pores of the wood product and adhere to the wood fibers; and (b) the ability to maintain visual appeal of the wood product while eliminating over 95%, in other embodiments 99% or more, of the ultraviolet radiation reaching the product. In another embodiment, this technique is used through incorporating the nanoparticles in wood polishes, wood protective sprays and other such protective varnishes and creams. One advantage of zinc-based UV absorbing powder is that they are environmentally benign when the product is disposed or destroyed by techniques such as incineration. While the teachings herein discuss the use of zinc metal comprising nanoscale and submicron powders, other compositions of powders that absorb UV radiation can also be employed in the same way to deliver similar benefits to consumers.

The teachings herein can be used to enhance the life of and protect paper, archival materials, prints, photographs, currency, valuable documents, such as passports, art work, fabric, and other products. These products degrade when exposed to light, in particular when exposed to ultraviolet radiation. In one embodiment, a method for enhancing the useful life of paper, archival materials, prints, photos, currency, valuable documents such as passports, fabric, art work, and other products, comprises (a) preparing nanoscale or submicron powders comprising zinc by any method, such as the method taught herein; (b) providing paper, archival materials, prints, photos, currency, valuable documents such as passports, fabric, art work, and other products; (c) infiltrating or coating the nanoscale or submicron powders onto the paper, archival materials, prints, photos, currency, valuable documents such as passports, fabric, art work and, other products; and (d) thereby reducing the UV radiation experienced by and consequent damage by UV to the paper, archival materials, prints, photos, currency, valuable documents such as passports, fabric, art work, and other products. A surprising advantage of the approach taught herein for protecting paper, archival materials, prints, photos, currency, valuable documents such as passports, fabric, art work, and other products is (a) the ability of nanoparticles to infiltrate or nanolayer coat the pores or ink of the product and adhere to the fibers constituting the product; and (b) the ability to maintain visual integrity and appeal of the product while eliminating over 95%, in other embodiments 99% or more, of the ultraviolet radiation reaching the product. In another embodiment, this technique is used through incorporating the nanoparticles in preservative polishes, protective sprays, and other such protective varnishes and creams. While the teachings herein discuss the use of zinc metal comprising nanoscale and submicron powders, other compositions of powders that absorb UV radiation can also be employed in the same way to deliver similar benefits to consumers or can be used in combination with zinc comprising nanoparticles to deliver value to consumers. Similarly, while UV pigments are discussed in detail, with composition optimization, zinc containing nanoparticles (such as Zinc Sulfide) can be made to reflect or absorb infrared (IR) wavelengths. Such IR pigments can be used with glass or plastics to improve thermal management of environment inside a package or inside a room.

### Sulfur Limiting Agent

The unusually high affinity of zinc oxide for sulfur when combined with nanoparticle technology enables novel applications. It can be used to capture or reduce the undesirable activity of sulfur in any process or product such as plastics, rubber, fuels, and acid rain causing exhaust gases. The high surface area of zinc oxide nanoparticles, particularly when the mean particle size is less than 100 nanometers, make them useful in these applications.

In one embodiment, a method for employing zinc comprising nanoparticles as sulfur limiting agent comprises (a) preparing nanoscale or submicron powders comprising zinc; (b) providing a powder or film of one or more plastics, wherein the plastics may be laminated or extruded or blown or cast or molded; and (c) integrating the nanoscale or submicron powders in or on the plastic by techniques such as spin coating, dip coating, spray coating, ion beam coating, vapor deposition, mixing, laminating, extruding, casting, molding, and sputtering.

### Electroceramics, Batteries and Fuel Cells

Nanoparticles comprising zinc offer several unusual benefits to electroceramic applications. These benefits are a consequence of (a) the small size of nanoparticles which can enable very thin film devices, (b) high surface area which can lower the sintering temperatures and sintering times, and (c) unusual grain boundary effects. These properties can be used to prepare electroceramic devices such as voltage-surge protection and current-surge protection components. Other nanodevices that can be prepared from nanoscale powders comprising zinc include chemical sensors, biomedical sensors, phosphors, and anti-static coatings.

Nanoparticles comprising zinc offer several benefits to zinc-air battery and fuel cell applications. These benefits are a consequence of (a) the small size of nanoparticles which can enable very thin film devices, (b) high surface area which can lower the forming temperatures and forming times, (c) unusual grain boundary effects, and (d) higher surface area for superior electrochemical kinetics. For these applications, nanoparticulate zinc dust can be prepared by processes as described herein or oxides comprising zinc can be reduced to prepare metallic nanoparticles comprising zinc. In certain embodiments for battery and fuel cell applications, the nanoparticles comprising zinc have a surface area greater than 1 m²/gm, in some embodiments greater than 5 m²/gm, and in other embodiments greater than 20 m²/gm. These nanoparticles can be used generally to prepare superior zinc-based batteries and/or fuel cells. Of particular relevance to zinc comprising nanoparticles are button type or miniature batteries used in applications such as, but not limited to, hearing aids, special effect glasses, etc.

Any method can be employed to utilize nanoparticles comprising zinc in electroceramic devices taught herein. In one embodiment, a method for employing zinc comprising nanoparticles in miniature batteries comprises (a) preparing nanoscale or submicron powders comprising zinc; (b) preparing an electrode from the powders; and (c) integrating the electrode prepared from the powders into a miniature battery.

### Electrically Conductive Materials and Coatings

Electrical, television communication, and wireless products create and emit electromagnetic radiation. These radiations can affect the proper and safe operation of other devices. In some circumstances, these electromagnetic radiation have been suggested to cause adverse reactions to physiology. Technologies that can provide shielding and protection from electromagnetic radiation are sought.

It is known to those in the electromagnetic radiation shielding art that conductive materials and coatings can provide such a shielding and protection function. Novel conductive materials and coatings are therefore desired by industry.

Similarly thin film heating elements such as those used in car wind shields and side and rear windows/glass seek novel conductive materials and coatings that are both transparent and conductive.

Displays in products such as flat panel displays, interactive kiosks, cellular phones, etc. use conductive films. The applications seek novel conductive materials and coatings that are both transparent and conductive.

Nanoparticles comprising two or more metals one of which is zinc can be made conductive. Zinc oxide by itself is a semiconducting substance. However, by doping zinc with an element with a different oxidation state, in some embodiments a higher oxidation state, conductive formulations can be achieved. Such a doping creates lattice defects and associated free electrons for electrical conductivity. The conductivity of the nanoparticles, measured at 100 kgf compressive pressure, can be higher than 0.000001 mhos·cm, in certain embodiments greater than 0.0001 mhos·com, in other embodiments greater than 0.01 mhos·com, in some embodiments greater than 1 mhos·cm, and in some embodiments greater than 100 mhos·com. The conductivity can be improved by reduction and by surface treatment.

In one embodiment, aluminum with oxidation state of 3 can be doped into the lattice of zinc oxide nanoparticles (with zinc oxidation state of 2) in concentrations between 0.1 atomic percent to 7.5 atomic percent (other ranges can be employed in different embodiments) to achieve conductivity that is over 10 times the conductivity of 99.99 atomic percent pure zinc oxide nanoparticles, in some embodiments over 1000 times the conductivity of 99.99 atomic percent pure zinc oxide nanoparticles, and in other embodiments over 100,000 times the conductivity of 99.99 atomic percent pure zinc oxide nanoparticles. Other non-limiting illustrations of dopants that can be used to enhance electrical conductivity in zinc oxide nanoparticles include B, Ga, In, Sn, Ti, Zr, Hf, V, Nb, Ta, Cr, W, Mo, Mn, and rare earth elements.

In certain embodiments, a particle size distribution such that the d₉₅ of particle size distribution is less than 500 nm is used, in other embodiments this is less than 100 nm. Once such multi-metal oxide nanoscale powder comprising Zn is available, it can be utilized to shield electromagnetic radiation. This powder can be mixed into products or applied as coatings by techniques such as spin coating, dip coating, casting, screen printing, and other known deposition techniques. If desired, the coatings can then be dried and/or calcined and/or sintered to achieve the best combination of structural, optical, thermal, electrical, magnetic, electrochemical, and other properties. It is recommended that such post processing be optimized to achieve or limit grain growth of the nanoparticles.

One of the unusual and surprising properties of doped zinc oxide nanoparticles, particularly with d₉₉ of 400 nm, and in other embodiments 200 nm, is that they offer conductivity and optical transparency with minimal haze. Furthermore, these formulations do not create an undesirable blue tinge that distorts color. This makes these materials suitable for preparing conductive and transparent coatings and films. Such a combination of conductive and transparent characteristics can be applied in heating films in automobile wind shields, defogging systems and/or deicing windows and mirrors, micro-displays, displays, device electrodes, solar cells and energy conversion devices, electrochromic systems, consumer advertising, product display cases, sensors, aircraft instruments and glasses, telescopes, microscopes, surgical visualization products, etc. Similarly, these conductive and transparent compositions can be applied to enhance electromagnetic shielding from products such as cathode ray tubes, electron beam activated or phosphor comprising products, to meet electromagnetic radiation emission requirements, and to meet electromagnetic radiation robustness requirements in consumer, scientific, or military products.

While the above discussion is presented in context of nanoparticles comprising two or more metals one of which is zinc, a more broader concept may be utilized to prepare conductive materials. Generally, any semiconducting nanoparticle can be doped to enhance electrical conductivity. More specifically, by doping a metal oxide, wherein the metal has a given oxidation state, with an element with different oxidation state, in certain embodiments higher oxidation state, conductive formulations can be achieved. Such a doping creates lattice defects and associated free electrons for electrical conductivity. For example, a metal with oxidation state of 3 can be doped into the lattice of metal oxide nanoparticles wherein the metal has an oxidation state of 2, where the doped metal is in concentrations between 0.1 atomic percent to 20 atomic percent thereby enhancing the conductivity over the conductivity of pure metal oxide. As another example, a metal with oxidation state of 4 can be doped into the lattice of a metal oxide nanoparticles wherein the metal has an oxidation state of 3, where the doped metal is in concentrations between 0.1 atomic percent to 20 atomic percent thereby enhancing the conductivity over the conductivity of pure metal oxide. In yet another example, a metal with oxidation state of 3 can be doped into the lattice of a metal oxide nanoparticles wherein the metal has an oxidation state of 1, where the doped metal is in concentrations between 0.1 atomic percent to 20 atomic percent thereby enhancing the conductivity over the conductivity of pure metal oxide. In another example, a metal with oxidation state of 1 can be doped into the lattice of a metal oxide nanoparticles wherein the metal has an oxidation state of 2, where the doped metal is in concentrations between 0.1 atomic percent to 20 atomic percent thereby modifying the conductivity over the conductivity of pure metal oxide. More than one dopant where the said dopants either have the same or different oxidation states between each other may be employed and the concentrations of the dopant can be different than the ranges suggested above. Additionally, the nanoparticles may be reduced (with hydrogen or carbon monoxide or ammonia etc) to modify the electrical properties of the nanoparticles. The applications taught herein for zinc containing conductive materials can be used for these materials as well.

In one embodiment, a method for shielding electromagetic radiation comprises (a) preparing nanoscale powders comprising two or more metals one of which is zinc by any process, such as a process taught herein; (b) providing a surface; (c) applying the nanoscale powders over the surface by techniques such as spin coating, dip coating, spraying, screen printing, casting and/or other deposition methods; and (d) processing the nanoscale powders by techniques such as drying, setting, calcining and/or sintering. In yet another embodiment, the zinc metal containing nanoscale or submicron powders are pretreated to coat the powder surface for ease in dispersability and to ensure homogeneity. In a further embodiment, glasses or polymers may be mixed with nanoscale powders before preparing a useful shielding product.

In one embodiment, a method for preparing transparent electrically conductive coatings or layers comprises (a) preparing nanoscale powders comprising two or more metals one of which is zinc by any process, such as a process taught herein; (b) providing a surface or substrate; (c) applying the nanoscale powders over the surface by techniques such as spin coating, dip coating, spraying, screen printing, casting, and/or other deposition methods; and (d) processing the nanoscale powders by techniques such as drying, setting, calcining, and/or sintering. In yet another embodiment, the zinc containing nanoscale or submicron powders are pretreated to coat the powder surface for ease in dispersability and to ensure homogeneity. In a further embodiment, glass or polymers may be mixed with nanoscale powders before preparing useful coatings or products.

In another embodiment, a method for preparing an electrode film comprises (a) preparing nanoscale powders comprising two or more metals one of which is zinc by any process, such as a process taught herein; (b) providing a surface or substrate; (c) applying the nanoscale powders over the surface by techniques such as spin coating, dip coating, spraying, screen printing, casting, and/or other deposition methods; and (d) processing the nanoscale powders by techniques such as drying, setting, calcining, and/or sintering. In yet another embodiment, the zinc metal containing nanoscale or submicron powders are pretreated to coat the powder surface for ease in dispersability and to ensure homogeneity. In a further embodiment, glass or polymers or additives or metals or combinations may be mixed with nanoscale powders before preparing the electrodes.

Conductive nanoparticles can also be utilized to provide conductive surfaces that resist dust collection. Many surfaces become unclean because they develop static charge over time for reasons such as natural air flow, dust collision, electron radiation, rubbing, etc. The static on the surface attracts dust of opposite charge thereby causing the dust to stick to the surface. By providing a conductive surface, in certain embodiments a transparent conductive surface, the surface charge can be dissipated and therefore the attractive forces between the surface and the dust in air can be reduced. If the attractive forces become too low, gravity and natural Brownian motion can help achieve a surface that reduces dust build up over time and thereby keeping surfaces clean longer. Such self clean preserving surfaces are desirable in product display cases in retails, for automotive windows and wind shields, aircraft parts, electronic and telecom displays, computer displays, micro-displays, watches, plastic products, glass products, ceramic products, bottles, jewelry, mirrors, glass windows, instruments, biomedical devices, clean rooms, etc.

In additional embodiments, conductive nanoparticles that are also UV absorbent could be used to provide multi-functional pigments—i.e., pigments that provide UV protection, that are transparent, and that are conductive enough to reduce dust build up. In one embodiment, such a nanoparticle pigment is aluminum doped zinc oxide, wherein aluminum concentration is less than 10 atomic percent by metal basis.

In other embodiments, nanoparticles comprising zinc compounds when incorporated in coatings can provide sustained deodorant, sanitizer, disinfectant, fungicide, virucide, and mildewstat functions. These functions can be particularly useful in ceilings, walls, floors, windows, carpets, furnitures, sanitary products, and other similar consumer products.

### Catalysts

Zinc containing nanoparticles can serve as excellent catalysts for a number of chemical reactions. For example, they can be used in methanol synthesis or in processes aiming to convert alcohols to hydrogen at low temperatures using nanoparticles comprising zinc. In one embodiment, a method for producing more desirable or valuable substances from less desirable or valuable substances comprises (a) preparing nanoscale multi-metal powders comprising zinc by any method, such as the method taught herein, such that the surface area of the said powder is greater than 25 square meter per gram, in some embodiments greater than 75 square meter per gram, and in some embodiments greater than 150 square meter per gram; and (b) reducing the powder in a reducing environment (or activating the powder in any other way) and then conducting a chemical reaction over the said nanoscale powders comprising doped or undoped zinc metals. In some embodiments, a further step of dispersing the nanoscale powders in a solvent and then depositing these powders onto a substrate from the dispersion may be employed before chemical reactions are conducted.

The catalyst powders described above can be combined with zeolites and other well defined porous materials to enhance the selectivity and yields of useful chemical reactions.

### Optics and Phosphors

Non-stoichiometric nanoparticles comprising zinc offer several unusual benefits as phosphors and for detector applications. These benefits are a consequence of one or more of the following characteristics (a) small size, (b) high surface area, (c) dispersability in various media, inks, and solid matrices, (e) unusual and complex combinations of density, vapor pressures, work functions, and band gaps. The advantages of phosphors and detectors comprising zinc-containing nanoparticles are (a) high dots per inch density, (b) ability to form homogeneous products, and (c) the ability to prepare very thin films thereby reducing the raw material required for same or superior performance. Nanoparticles can also be post-processed (calcination, sintering) to grow the grain to the optimal size in order to provide the brightness level, decay time and other characteristics as desired.

Multi-metal compositions (two, three, four, or more metals) comprising zinc are used in certain embodiments. These phosphor nanopowders can be used for display applications, lamps, fluorescent bulbs, light emitting devices, markers, security pigments, fabric pigments, paints, toys, special effects, etc.

### Biomedical Applications and Dental Cements

Nanoparticles comprising zinc offer several benefits in health care and biomedical applications. Zinc is one of the essential elements for plants and animals. In humans, zinc is the most prevalent micronutrient next to iron. Zinc oxide nanoparticles of pharmaceutical purity when used in current formulations can enable faster assimilation and improved assimilation. This benefit is a consequence of one or more of the following characteristics (a) small size, (b) high surface area, and (c) dispersability in various media. Similarly, zinc comprising nanoparticles can serve as nutrients for plants, agriculture, flowers, and pets. Other uses of zinc oxide nanoparticles include dental cement wherein the nanoscale can enhance the functionality of zinc oxide in the cement.

Quality wound healing formulations, creams, lotions, and sprays can be prepared from nanoscale powders of zinc oxides and zinc compounds. The role of zinc oxide has been described by Argen et al. (EWMA Journal, vol 1, number 1, pages 15-17 (2001)) which along with references cited therein is hereby incorporated by reference in full. The Argen et al. study and current commercial products, such as diaper rash soothing creams and anti-itch creams, incorporate coarse zinc oxide powders. The benefit of nanoscale powders taught herein and produced by methods, such as the methods taught herein, can yield superior wound management, diaper rash soothing creams, anti-itch creams, and other such products. The superior performance of nanoscale powders comprising zinc is a consequence of one or more of the following characteristics (a) small size that can better reach finer and deeper into pores/cuts/rash and thereby provide a reservoir of zinc, (b) high surface area that can enhance the dissolution rate and pharmokinetic processes, (c) homogeneous distribution of the particles per unit amount applied which means more effective application and superior Fick's diffusion, (d) the mild anti-bacterial, anti-inflammatory, anti-microbials and cytoprotective activity, and (e) dispersability in various media for more uniform and sustained release.

In one embodiment, an anti-inflammatory cream, lotion, stick, spray, bandage, product is prepared and used as follows: (a) prepare nanoscale or submicron oxide powders comprising zinc in a process, such as a process taught herein; (b) provide a medium, such as a cream, base, wax, spray, or solution; (c) disperse the nanoscale or submicron powders into the medium; and (d) apply the medium over the surface that can benefit from inflammatory protection. In one embodiment, this method can be used in existing anti-inflammatory products or personal care products. Like anti-inflammatory products in the embodiment above, superior products incorporating nanoparticles comprising zinc oxide can be prepared for the care of burns, blisters, gum disease, sunburn, and insect bites. Similarly, superior products incorporating nanoparticles comprising zinc oxide can be prepared for healing of wounds, such as cuts, skin irritations, abrasions, burns, sores, and the healing of wounds that result from surgical incisions.

Nanoparticles of zinc oxide can also be included in the liner of bandages, flexible cloths, and pads to enhance the usefulness of these products. In one embodiment, a bandage or personal care product is prepared and used to provide faster healing as follows: (a) prepare nanoscale or submicron powders comprising zinc in a process, such as a process taught herein; (b) provide a bandage or personal care product; (c) disperse the nanoscale or submicron powders onto or into the bandage or personal care product; and (d) apply the bandage or personal care product over the surface that needs to be healed. Alternatively, nanoparticles comprising zinc can be coated, bonded, or trapped into textiles or on the surface of textiles to provide sustained protection or to prepare products for those with chronic tissue damage. Combined with other nanoparticles such as those taught herein (astringent, deodorant, etc.), multi-functional textiles and wound care products can be prepared.

The above embodiments for various products can be applied alone or in combination with other functional additives such as deodorants, nutrients, lubricants, analgesics, anti-microbials, pigments, perfumes, etc.

### Reagent and Raw Material for Synthesis

Nanoparticles of zinc oxide and zinc containing multi-metal oxide nanoparticles are useful reagents and precursors to prepare other compositions of nanoparticles comprising zinc. In a generic sense, nanoparticles comprising zinc are reacted with another substance such as, but not limited to, an acid, alkali, organic, monomer, ammonia, halogens, phosphorus compounds, chalcogenides, biological materials, gas, vapor or solvent; the high surface area of nanoparticles facilitates the reaction and the product resulting from this reaction is also nanoparticles. These product nanoparticles can then be suitably applied or utilized to catalyze or as reagents to prepare other fine chemicals for a wide range of applications. A few non-limiting illustrations utilizing zinc comprising nanoparticles follow. These teachings can be extended to multi-metal oxides and to other compositions such as zinc acetate and organometallics based on zinc. In certain embodiments, the nanoparticles may be treated or functionalized or activated under various temperatures, pressure, charge or environment composition before use.

Zinc Fluoride: Zinc oxide nanoparticles are reacted with aqueous hydrofluoric acid to produce nanoparticles of ZnF₂.4H₂O. If desired, the water of crystallization can be driven off by heating the nanocrystals in a vacuum or ambient pressures or higher pressures at temperatures such as 400 K, 800 K, 1200 K, etc. Zinc fluoride nanoparticles are commercially valuable in glasses with high refractive index, glazes and enamels for porcelain, as an additive to electrolytic galvanizing baths, fluorinating agent in organic synthesis, and as a flux in welding and soldering particularly in micro-welding or micro-soldering. In some applications, such as conductive coating, nanoparticles of partially fluorinated zinc oxide (e.g. ZnO.F) may be desirable. These can be prepared by treating zinc oxide nanoparticles with hydrofluoric vapors or through controlled reaction of zinc oxide with HF in solution. In one embodiment, a method for producing nanoparticles comprising zinc and fluorine comprises (a) preparing nanoscale powders comprising zinc by any method, such as a method herein; (b) reacting the nanoscale powders with a fluid comprising hydrogen fluoride; and (c) collecting resultant nanoparticles comprising zinc and fluorine. In another embodiment, a method for applying nanoparticles comprising zinc and fluorine is a high refractive index glass prepared from nanoparticles of zinc fluoride; more specifically, a high refractive index glass comprising (a) preparing nanoscale powders comprising zinc and fluorine by any method, such as a method taught herein; and (b) utilizing the nanoscale powders to prepare glass with high refractive index.

Zinc Chloride: Zinc metal nanoparticles or zinc oxide nanoparticles are reacted with fluid comprising hydrochloric acid to produce nanoparticles of ZnCl₂. It is important to note that zinc chloride is strongly hygroscopic and results in very high heat evolution when water vapor combines with zinc chloride. Solvents such as alcohol, ether, acetone, glycerine, amines, and acetates may be used to provide better reaction control given the solubility of zinc chloride in these solvents. Zinc chloride nanoparticles are commercially valuable as organic condensation reaction catalysts, catalysts to prepare chloroalkanes, chloroaromatics and thiocarbamates, hydrolysis catalysts, and other catalysts. Zinc chloride nanoparticles can be used to prepare superior emulsion breakers in petrochemical processes and waste spills, deodorizing agent, zinc soaps, and filling materials for batteries. Additionally, zinc chloride nanoparticles can be used as reagents to prepare useful chemicals such as zinc cyanide and aquoacids. A non-limiting synthesis embodiment for a method for producing nanoparticles comprising zinc and chlorine comprises (a) preparing nanoscale powders comprising zinc by any method, such a method taught herein; (b) reacting the nanoscale powders with a fluid comprising hydrogen chloride; and (c) collecting resultant nanoparticles comprising zinc and chlorine. In one embodiment, a method for applying nanoparticles comprising zinc and chlorine is a battery filling material prepared from nanoparticles of zinc chloride; more specifically, a battery comprising nanoparticles of zinc chloride.

Zinc Bromide: Zinc metal nanoparticles or zinc oxide nanoparticles are reacted with fluid comprising hydrobromic acid to produce nanoparticles of ZnBr₂. Zinc bromide nanoparticles are also strongly hygroscopic like zinc chloride. Anhydrous zinc bromide nanoparticles can be formed by thermal treatments in a suitable environment such as dry CO₂, at temperatures such as between 500 K-1000 K. Zinc bromide nanoparticles can be used to prepare superior electrolytes for zinc bromide batteries, as a mild Lewis acid for alkylation reactions, a catalyst, production of porous or activated materials such as carbon, and in photographic materials. In one embodiment, a method for producing nanoparticles comprising zinc and bromine comprises (a) preparing nanoscale powders comprising zinc by any method, such as the method taught herein; (b) reacting the nanoscale powders with a fluid comprising hydrogen bromide; and (c) collecting resultant nanoparticles comprising zinc and bromine. In one embodiment applying these nanoparticles, a method for applying nanoparticles comprising zinc and bromine is a battery electrolyte prepared from nanoparticles of zinc bromide; more specifically, a battery comprising nanoparticles of zinc bromide.

Zinc Iodide: Zinc metal nanoparticles directly or zinc oxide nanoparticles in presence of catalyst, such as precipitated silver, are reacted with fluid comprising aqueous hydroiodic acid to produce nanoparticles of ZnI₂. Zinc iodide nanoparticles are also hygroscopic like zinc chloride. Zinc iodide nanoparticles can be used as a superior topical antiseptic astringent. The advantage of nanoparticles is their small size (which is less than the skin pores size and the pore size of undesirable and harmful microorganisms) which means lesser quantities may provide sufficient yet complete, faster, superior and homogeneous application near target areas.

In one embodiment, the present invention provides an antiseptic prepared with nanoparticles comprising a halide such as iodine. More specifically, a method for applying nanoparticles comprising zinc and iodine is an antiseptic astringent comprising nanoparticles of zinc iodide.

Zinc Sulfate: Zinc metal nanoparticles directly or zinc oxide nanoparticles are reacted with fluid comprising sulfuric acid to produce nanoparticles of hydrated ZnSO₄. Anhydrous zinc sulfate nanoparticles can be prepared by heat treating hydrated zinc sulfate usually below 400 K or with dehydrating the crystals with alcohols. Zinc sulfate nanoparticles offer higher surface areas, faster dissolution, and small size (which means that they can reach smaller target areas). Zinc sulfate nanoparticles can be used as a superior water treatment chemical, an electrolyte in galvanizing baths, a zinc nutrient source for plants and animals, a wood preservative, a flocculant, and as an additive in paper bleaching. Zinc sulfate nanoparticles are also excellent raw materials for the manufacture of nanoparticles or coarser forms of zinc soaps, zinc phosphides, zinc cyanamide, lithopone pigment, zinc sulfide pigment, antidandruff agents, such as zinc pyrithione, and zinc-based fungicides.

Another application of zinc sulfate nanoparticles is as an emetic, astringent, and disinfectant. The advantage of nanoparticles is their small size (which is less than the skin pore size and the pore size of undesirable and harmful microorganisms) which means lesser quantities may provide sufficient yet complete, faster, superior, and homogeneous application near target areas. Zinc sulfate nanoparticles may be dispersed in glycerine or other solvents for ease of application.

In one embodiment, a disinfectant prepared with nanoparticles comprising a sulfur or halide is provided. More specifically, a method for applying nanoparticles comprising zinc sulfate is a disinfectant comprising nanoparticles of zinc sulfate.

### Examples 1-2

### Zinc Oxide Powders

99 weight % by metal pure zinc ethylhexanoate precursor was diluted with hexane until the viscosity of the precursor was less than 100 cP. This mix was sprayed into a thermal plasma reactor described above at a rate of about 50 ml/min using about 50 standard liters per minute oxygen. The peak temperature in the thermal plasma reactor was above 3000 K. The vapor was cooled to nucleate nanoparticles and then quenched by Joule-Thompson expansion. The powders collected were analyzed using X-ray diffraction (Warren-Averbach analysis) and BET. It was discovered that the powders had a crystallite size of less than 50 nm and a specific surface area of about 10 m²/gm.

Next, in a separate run with the same process, the mix was sprayed at a rate of about 50 ml/min using about 65 standard liters per minute oxygen. The peak temperature in the thermal plasma reactor was above 3000 K. The vapor was cooled and then quenched by Joule-Thompson expansion. The powders collected were analyzed using X-ray diffraction (Warren-Averbach analysis) and BET. It was discovered that the powders had a crystallite size of about 35 nm and a specific surface area of about 14 m²/gm.

These examples show that nanoparticles comprising zinc can be prepared and that the characteristics of zinc oxide powder can be varied with process variations.

### Examples 3

### Nickel Zinc Ferrite Powders

A mixture of nickel, zinc, and iron organometallic (octoates, 1:1:2 Ni:Zn:Fe ratios) precursor was prepared. Using the process of Example 1, the mixture was processed at a peak temperature exceeding 2000 K, and the powder was collected. The powders were characterized using X-ray diffractometer and 10 point BET surface area analyzer. The powders were found to be nickel zinc ferrite nanoparticles. No independent peaks of zinc, nickel, or iron oxide were observed suggesting lattice level mixing of atoms. The powders were of a brown color, and had a mean crystallite size less than 15 nanometers and a surface area greater than 40 m²/gm. The powders were found to be magnetic.

This example shows that color pigment nanoparticles can be prepared from zinc and that complex three metal oxide nanoparticles can be produced.

### Example 4

### Aluminum Doped Zinc Oxide Powders

A mixture of aluminum and zinc organometallic precursors were prepared. The ratio was adjusted between the two metal precursors to achieve 1.5 wt % aluminum oxide and 98.5 wt % zinc oxide. Using the process of Example 1, the mixture was processed at a peak temperature exceeding 2000 K, and the powder was collected. The powders were characterized using X-ray diffractometer and 10 point BET surface area analyzer. The powders were found to be doped zinc oxide nanoparticles. No independent peaks of zinc or aluminum oxide were observed suggesting lattice level mixing of atoms. The powders had a mean crystallite size of about 25 nanometers and a surface area of about 20 m²/gm. Electrical conductivity of zinc oxide from Example 1 and aluminum-doped zinc oxide from this example were measured. It was discovered that the doped zinc oxide was over 10 times more conductive than the pure zinc oxide nanopowder.

This example shows that electrically conductive nanoparticles can be prepared from zinc and that doped zinc oxides offer unusual and surprising properties.

### Example 5

### Bismuth and Cobalt Doped Zinc Oxide

A mixture of bismuth, cobalt and zinc, organometallic precursors were prepared. Using the process of Example 1, the mixture was processed at a peak temperature exceeding 2000 K, and the powder was collected. The powders were characterized using X-ray diffractometer and 10 point BET surface area analyzer. The powders were found to be doped zinc oxide nanoparticles. The powders had a mean crystallite size of less than 100 nanometers and a surface area greater than 5 m²/gm.

### Example 6-7

### Zinc Oxide Nanoparticles as Reagent

Zinc oxide nanoparticles from Example 2 were added to 2-ethyl hexanoic acid (2-EH) distributed by Ashland Chemicals in 1:2 molar ratio respectively. The mixture was stirred using a magnetic stirrer and warmed to 70° C. It was observed that the zinc oxide nanoparticles vigorously reacted with 2-EH and formed a composition different than either ZnO or 2-EH.

Zinc oxide nanoparticles prepared in Example 2 were reduced in a mixture of 5% hydrogen in argon by passing the reducing gas in a tubular reactor maintained at various temperatures. It was observed that zinc oxide can be converted to zinc dust at temperatures above 400° C. These example illustrates the beneficial aspects of zinc oxide nanoparticles as a reagent.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A coating, comprising a nanomaterial composition comprising zinc and at least one metal other than zinc, wherein the at least one metal comprises an element that (a) has an oxidation state higher than an oxidation state of zinc and that (b) dopes zinc in the nanomaterial composition, and wherein the coating has an electrical conductivity greater than 0.0001 mhos·cm.

2. The coating of claim 1, wherein the at least one metal comprises aluminum.

3. The coating of claim 1, wherein the at least one metal comprises one or more elements chosen from B, In, Ga, Sn, Ti, Zr, V, Hf, Nb, Ta, Cr, W, Mo, Mn, and rare earth elements.

4. The coating of claim 1, wherein the electrical conductivity is greater than 0.01 mhos·cm.

5. The coating of claim 1, wherein the coating comprises one or more ingredients chosen from glasses and polymers.

6. The coating of claim 1, wherein the at least one metal comprises one or more elements chosen from Al, B, In, Ga, Sn, Ti, Zr, V, Hf, Nb, Ta, Cr, W, Mo, Mn, and rare earth elements; wherein the electrical conductivity is greater than 0.01 mhos·cm; and wherein the coating comprises one or more ingredients chosen from glasses and polymers.

7. An electrode comprising a coating, comprising a nanomaterial composition comprising zinc and at least one metal other than zinc, wherein the at least one metal comprises an element that (a) has an oxidation state higher than an oxidation state of zinc and that (b) dopes zinc in the nanomaterial composition, and wherein the coating has an electrical conductivity greater than 0.0001 mhos·cm.

8. The electrode of claim 7, wherein the at least one metal comprises one or more elements chosen from Al, B, In, Ga, Sn, Ti, Zr, V, Hf, Nb, Ta, Cr, W, Mo, Mn, and rare earth elements.

9. The electrode of claim 7, comprising one or more ingredients chosen from glasses and polymers.

10. The electrode of claim 7, wherein the at least one metal comprises one or more elements chosen from Al, B, In, Ga, Sn, Ti, Zr, V, Hf, Nb, Ta, Cr, W, Mo, Mn, and rare earth elements; wherein the electrical conductivity is greater than 0.01 mhos·cm; and wherein the coating comprises one or more ingredients chosen from glasses and polymers.

11. A method, comprising applying a coating to a substrate, wherein the coating comprises a nanomaterial composition comprising zinc and at least one metal other than zinc, wherein the at least one metal comprises an element that (a) has an oxidation state higher than an oxidation state of zinc and that (b) dopes zinc in the nanomaterial composition, and wherein the coating has an electrical conductivity greater than 0.0001 mhos·cm.

12. The method of claim 11, wherein the at least one metal comprises aluminum.

13. The method of claim 11, wherein the at least one metal comprises one or more elements chosen from B, In, Ga, Sn, Ti, Zr, V, Hf, Nb, Ta, Cr, W, Mo, Mn, and rare earth elements.

14. The method of claim 11, wherein the electrical conductivity is greater than 0.01 mhos·cm.

15. The method of claim 11, wherein the coating comprises one or more ingredients chosen from glasses and polymers.

16. The method of claim 11, wherein the at least one metal comprises one or more elements chosen from Al, B, In, Ga, Sn, Ti, Zr, V, Hf, Nb, Ta, Cr, W, Mo, Mn, and rare earth elements; wherein the electrical conductivity is greater than 0.01 mhos·cm; and wherein the coating comprises one or more ingredients chosen from glasses and polymers.

17. The method of claim 16, wherein the coated substrate is in the form of an electrode.

18. The method of claim 11, wherein the coated substrate is in the form of an electrode.

19. The electrode of claim 18, wherein the at least one metal comprises one or more elements chosen from Al, B, In, Ga, Sn, Ti, Zr, V, Hf, Nb, Ta, Cr, W, Mo, Mn, and rare earth elements.

20. The method of claim 18, wherein the electrode comprises one or more ingredients chosen from glasses and polymers.
